(19) United States
(12) Patent Application Publication
(10) Pub. No.: US 2024/0033543 A1
(43) Pub. Date: Feb. 1, 2024

(54) NOSE BREATHING DEVICE

(71) Applicant: SINWOO TECH INDUSTRY LTD., Cheongju-si, Chungcheongbuk-do (KR)

(72) Inventor: Kum Jin JEON, Incheon (KR)

(73) Assignee: SINWOO TECH INDUSTRY LTD., Cheongju-si, Chungcheongbuk-do (KR)

(21) Appl. No.: 18/034,633

(22) PCT Filed: Sep. 28, 2021
(86) PCT No.: PCT/KR2021/013181

§ 371 Date: Apr. 28, 2023

(30) Foreign Application Priority Data
Apr. 20, 2021 (KR) 10-2021-0051333

(51) Int. Cl. A62B 7/10; A62B 9/02; A62B 23/06; A62B 9/04

(52) U.S. Cl. CPC A62B 7/10; A62B 9/02; A62B 23/06; A62B 9/04

(57) ABSTRACT

The present invention relates to a nose breathing device and, more specifically, to a nose breathing device worn along with a mask to prevent dew condensation from occurring in the mask due to breathing of a user and the occurrence of skin troubles and respiratory diseases. The present invention comprises: a pair of respiratory tube bodies (10) including inhaling tubes (11), which are inserted in the nose of a user, and exhaling tubes (13), which are branched from the sides of the inhaling tubes (11); an inhaling check valve (20) which is assembled in an inhaling air accommodation space (S1) of the inhaling tube (11) and is operated so that an air suction port (12) is opened during inhalation and is closed during exhalation; an exhaling check valve (30) which is assembled in an exhaling air accommodation space (S2) of the exhaling tube (13) and is operated so that an air outlet port (14) is closed during inhalation and is opened during exhalation; and a discharge hose (40) which is assembled with the front end portion of the exhaling tube (13) and discharges exhaling air to the outside of a mask (M).

### TECHNICAL FIELD

The present invention relates to a nose breathing device, and more specifically, to a nose breathing device that is worn together with a mask to prevent moisture formation in the mask due to breathing of a user and occurrence of skin troubles and respiratory diseases.

### BACKGROUND ART

In general, the easiest and easiest way to block foreign substances or dust in the air, or bacterial bacteria or viruses is to wear a mask.

In particular, in the change of seasons such as spring and autumn, the number of people wearing masks is increasing in order to prevent the occurrence of various respiratory diseases such as allergy or asthma caused by yellow dust or pollen.

In addition, the importance of masks is increasing in order to prevent diseases transmitted through the respiratory system, such as novel influenza (H1N1), Middle East respiratory syndrome (MERS), and coronavirus (COVID).

A mask that is widely used in general may include a main body covering a nose and a mouth of a wearer and wearing bands for wearing the mask by hanging the mask on ears.

Such a mask is mainly manufactured by sewing and stitching cotton or textile materials, and when the wearer breathes while wearing the mask, humidity and temperature in a space between a face of the wearer and the mask are increased through a repeated process of inhalation and exhalation.

Therefore, when the wearer wears the mask for a long time, a skin around the nose and mouth of the wearer wearing the mask is exposed to moisture, causing skin troubles and various skin diseases.

In addition, in a seasonal environment such as the winter season, humidity increases according to a difference between inner and outer temperatures of the mask during breathing of the wearer, and in severe cases, water drops are formed on an inner surface of the mask, so that the wearer have to take off the mask, and during exhalation, warm air is discharged through a gap above the nose, so that fogging causes in glasses, resulting in obstruction of a view.

### DISCLOSURE

### Technical Problem

To solve the problems of the related art as described above, an object of the present invention is to provide a nose breathing device which is worn on a nose of a user, including the mask, to prevent a reverse flow of inhaling air and exhaling air during breathing of the user and to allow the user to stably breath.

Another object of the present invention is to provide a nose breathing device which directly discharges exhaling air of a wearer to the outside so as to keep the inside of the mask pleasant such that cleanliness around the mouth of the user wearing the mask can be maintained and skin troubles can be prevented and to prevent fogging of glasses.

Still another object of the present invention is to provide a nose breathing device which filters and discharges air discharged due to exhalation of the wearer even if the wearer is a virus carrier, so that the spread of viruses can be prevented to rapidly normalize social safety.

### Technical Solution

According to the present invention for solving the technical problem as described above, a nose breathing device includes:
a pair of respiratory tube bodies (10) including inhaling tubes (13), which are inserted into a nose of a user, and exhaling tubes (13), which are branched from sides of the inhaling tubes (11);
an inhaling check valve (20) which is assembled in an inhaling air accommodation space (S1) of the inhaling tube (11) and is operated so that an air suction port (12) is opened during inhalation and is closed during exhalation;
an exhaling check valve (30) which is assembled in an exhaling air accommodation space (S2) of the exhaling tube (13) and is operated so that an air outlet port (14) is closed during inhalation and is opened during exhalation; and
a discharge hose (40) which is assembled to a front end portion of the exhaling tube (13) to discharge exhaling air to an outside of a mask (M).

In addition, the respiratory tube body (10) has a soft silicone insertion member 16 assembled to a front end of the inhaling tube (11) and making close contact with an inner wall surface of the nose of the user.

In addition, the inhaling check valve (20) may include: an inhaling check ball (21) which has a spherical shape and moves along the inhaling air accommodation space (S1); an inhaling mesh plate (23) which is supported by a fixed protruding jaw (15) provided inside the inhaling tube (11) so as to control inward movement of the inhaling check ball (21) and allow air to move through a plurality of inhaling ventilation holes (23a); and an inhalation ball blocking ring (22) which is assembled to a front end portion of the inhaling tube (11) such that an inhalation ball locking jaw (22a) is positioned on an inner surface of the inhaling tube (11) so as to control movement of the inhaling check ball (21) to a front end side of the inhaling tube (11).

In addition, the exhaling check valve (30) may include: an exhaling check ball (31) which has a spherical shape and moves along the exhaling air accommodation space (S2); an exhalation ball blocking ring (32) which is supported by a fixed protruding jaw (15) provided inside the exhaling tube (13) so as to control inward movement of the exhaling check ball (31); and an exhaling mesh plate (33) which is assembled to the front end portion of the exhaling tube (13) so as to control movement of the exhaling check ball (31) to a front end side of the exhaling tube (13) and allow the air to move through a plurality of exhaling ventilation holes (33a).

In addition, the respiratory tube body (10) may be assembled by fitting an outer surface of the inhaling tube (11) into at least one tube connection member (19) formed at both sides thereof with tube fitting holes (19a) that are opened.

In addition, the discharge hose (40) may have an adsorption filter (70) accommodated therein, and may be connected to a purification device (50) supported on a circumference of a head or a neck of a wearer at a rear of the wearer so as to filter harmful substances in the air discharged through the discharge hose (40) and discharge the filtered harmful substances.

In addition, the purification device (50) may include: a filter tube (60) which has a tubular shape and is provided at both sides thereof with hose connectors (61); a spiral support (65) which is inserted into the filter tube (60) and supports a shape of the filter tube (60); an adsorption filter (70) which has a cylindrical shape and formed at an inside thereof with a central discharge path (71) extending in a longitudinal direction to filter the air introduced through the hose connectors (61) of the filter tube (60) so as to allow the filtered air to move through the central discharge path (71); and filter caps (80) which are assembled to both end portions of the filter tube (60) so as to fix a position of the adsorption filter (70) and includes an air discharge port (81) communicating with the central discharge path (71).

### Advantageous Effects

According to the present invention, the nose breathing device is worn on the nose of the user, including the mask, and the user inhales air filtered through the mask and discharges the air to the outside of the mask so as to keep the inside of the mask pleasant so that cleanliness around the mouth of the user wearing the mask can be maintained and skin troubles can be prevented and to prevent fogging of glasses, thereby improving convenience of use.

In addition, the nose breathing device is mounted on the nose of the user to prevent a reverse flow of inhaling air and exhaling air during breathing, thereby allowing the user to stably breathe and preventing malfunction of a product with a relatively simple configuration.

In addition, the purification device is connected to the nose breathing device to filter and discharge the air discharged through exhalation even if the user is a virus carrier, so that the re-spread of viruses can be prevented to rapidly normalize social safety, and movements or outdoor activities are possible in a state where the user wears the nose breathing device on the neck of the user, so that the nose breathing device is convenient to carry, thereby improving satisfaction of a product.

### DESCRIPTION OF DRAWINGS

FIG. 1 is a perspective view illustrating an overall configuration of a nose breathing device according to the present invention.

FIG. 2 is a use state diagram of the nose breathing device according to the present invention.

FIG. 3 is an exploded sectional view of the nose breathing device according to the present invention.

FIG. 4 is a sectional view illustrating an inhalation process of the nose breathing device of the present invention.

FIG. 5 is a sectional view illustrating an exhalation process of the nose breathing device according to the present invention.

FIG. 6 is an exploded perspective view illustrating a configuration of a purification device according to the present invention.

FIG. 7 is a plan sectional view illustrating a configuration of the purification device according to the present invention.

### BEST MODE

A nose breathing device according to the present invention is worn together with a mask to prevent moisture formation in the mask due to breathing of a user and occurrence of skin troubles and respiratory diseases.

Hereinafter, features of a configuration of the nose breathing device according to the present invention will be understood by the embodiments described in detail with reference to the accompanying drawings.

Since the present invention may be modified in various ways and may have various forms, embodiments will be described in detail in the specification. However, this is not intended to limit the present invention to the specific embodiments, and it should be understood that the present invention includes all modifications, equivalents, and replacements included within the spirit and technical scope of the present invention.

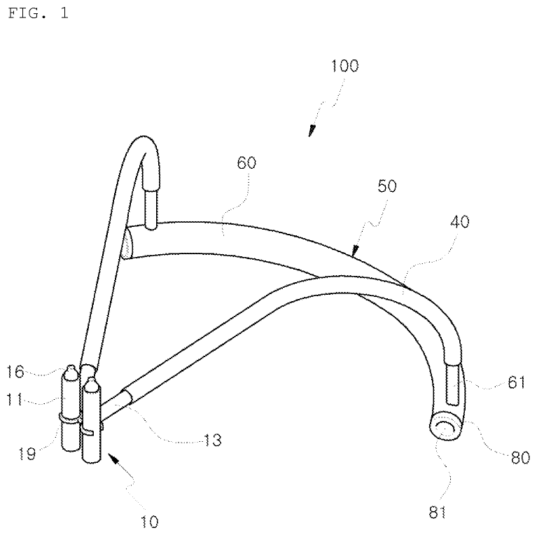

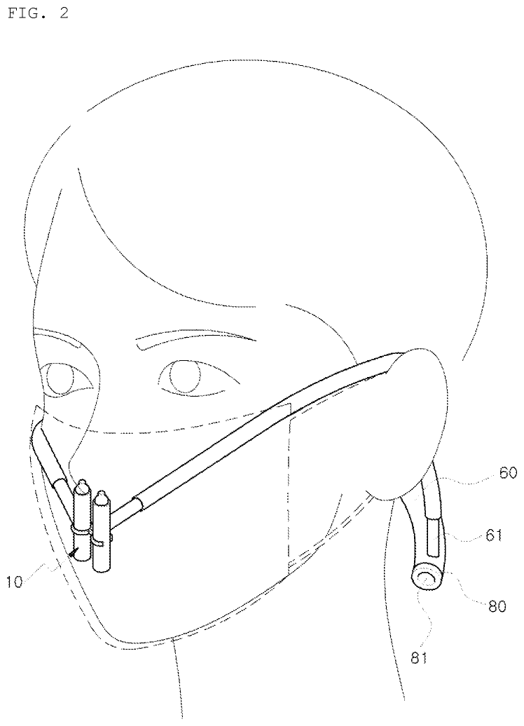

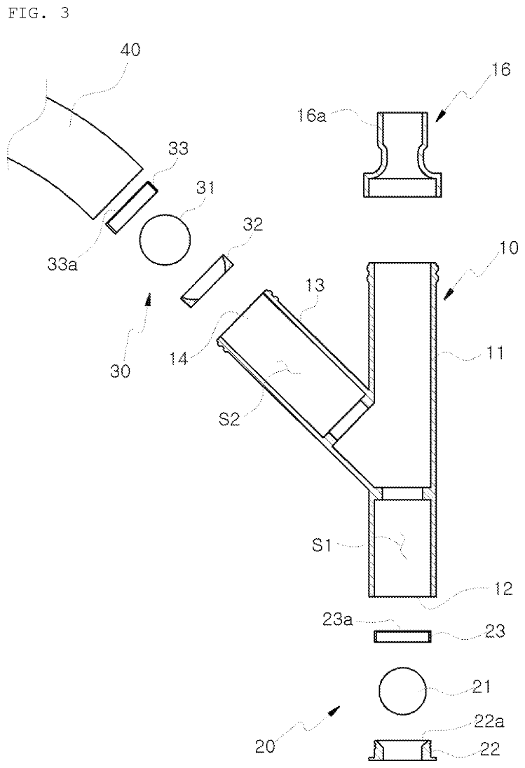

First, as shown in FIGS. 1 to 5, a nose breathing device 100 to which the present invention is applied largely includes an inhaling check valve 20 and an exhaling check valve 30, which are assembled to respiratory tube bodies 10 that are inserted into a nose of a user, and a discharge hose 40 which is connected to exhaling tubes 13 of the respiratory tube bodies 10 and is drawn to the outside of a mask M so as to discharge moisture included in exhaling air to the outside.

A pair of respiratory tube bodies 10 include inhaling tubes 11, which have a pipe shape and are inserted into the nose of the user, and the exhaling tubes 13, which have a ‘y’ shape branched from sides of the inhaling tubes 11 and are fitted into left and right nostrils, respectively.

In addition, the respiratory tube body 10 is assembled by fitting an outer surface of the inhaling tube 11 into at least one tube connection member 19 formed at both sides thereof with tube fitting holes 19a that are opened, and in an embodiment, the pair of respiratory tube bodies 10 are adjacent to each other, and then are fixed by fitting an upper side and lower side of the inhaling tube 11 into the tube fitting holes 19a using the tube connection member 19.

In this case, the inhaling tube 11 preferably has a linear shape such that the inhaling tube 11 is positioned between the mask M and the nose of the user to allow the user to easily breathe, and the exhaling tube 13 is preferably branched from the inhaling tube 11 such that air is easily discharged to the outside of the mask M.

In addition, the respiratory tube body 10 has a soft silicone insertion member 16 assembled to a front end of the inhaling tube 11 and making close contact with an inner wall surface of the nose of the user, and a lower portion of the soft silicone insertion member 16 in the drawing is airtightly fitted around an outer circumference of the front end of the inhaling tube 11, and the nose fitting port 16a that is an upper portion in the drawing is configured to have a relatively smaller diameter, thereby improving an air suction rate. However, the silicone insertion member 16 is not limited to any one shape, and may be modified in various forms according to a request of those skilled in the art.

In addition, fixed protruding jaws 15 may protrude from inner circumferences of the inhaling tube 11 and the exhaling tube 13 while being spaced apart from front ends of an air suction port 12 and an air outlet port 14 by a predetermined interval, so that an inhaling air accommodation space S1 where the inhaling check valve 20 is assembled and an exhaling air accommodation space S2 where the exhaling check valve 30 is assembled may be formed between the fixed protruding jaws 15 and each front end,

That is, the inhaling check valve 20 is assembled in the inhaling air accommodation space S1 of the inhaling tube 11 and is operated so that the air suction port 12 is opened during inhalation and the air suction port 12 is closed during exhalation, and the exhaling check valve 30 is assembled to the exhaling air accommodation space S2 of the exhaling tube 13 and is operated so that the air outlet port 14 is closed during inhalation and the air outlet port 14 is opened during exhalation.

The inhaling check valve 20 includes: an inhaling check ball 21 which has a spherical shape and moves along the inhaling air accommodation space S1; an inhaling mesh plate 23 which is supported by the fixed protruding jaw 15 provided inside the inhaling tube 11 so as to control inward movement of the inhaling check ball 21 and allow air to move through a plurality of inhaling ventilation holes 23a; and an inhalation ball blocking ring 22 which is assembled to the front end of the air suction port 12 of the inhaling tube 11 such that an inhalation ball locking jaw 22a is positioned on the inner surface of the inhaling tube 11 so as to control escape of the inhaling check ball 21 to the outside through the air suction port 12.

In this case, the inhaling mesh plate 23 has a cylindrical shape and an outer surface thereof is supported by an inner surface of the inhaling tube 11, so as not to move even by continuous impact of the inhaling check ball 21.

The inhalation ball blocking ring 22 forms a smaller ventilation hole (not shown) through which the air may move in the center thereof to airtightly fix the inhalation ball locking jaw 22a on the inner surface of the inhaling tube 11, and a curved groove corresponding to an outer diameter of the inhaling check ball 21 is formed around the ventilation hole so that the inhaling check ball 21 is in line or surface contact with the inhalation ball blocking ring 22.

In addition, the exhaling check valve 30 includes: an exhaling check ball 31 which has a spherical shape and moves along the exhaling air accommodation space S2; an exhalation ball blocking ring 32 which is supported by the fixed protruding jaw 15 provided inside the exhaling tube 13 so as to control inward movement of the exhaling check ball 31; and an exhaling mesh plate 33 which is assembled to the front end of the air outlet port 14 of the exhaling tube 13 so as to control escape of the exhaling check ball 31 to the outside through the air outlet port 14 and allow the air to move through a plurality of exhaling ventilation holes 33a.

In this case, the exhalation ball blocking ring 32 forms a smaller ventilation hole (not shown) through which the air may move in the center thereof and an outer surface thereof is inserted into the inner surface of the exhaling tube 13 so that the exhalation ball blocking ring 32 is supported by the fixed protruding jaws 15, and a curved groove corresponding to an outer diameter of the exhaling check ball 31 is formed around the ventilation hole so that the exhaling check ball 31 is in line or surface contact with the exhalation ball blocking ring 32.

In addition, the exhaling mesh plate 33 has a cylindrical shape and is fixed to the front end of the air outlet port 14 so as not to move even by continuous impact of the inhaling check ball 21 moving in the exhaling air accommodation space S2.

In addition, a flexible and soft discharge hose 40 is further assembled to the air outlet port 14 of the exhaling tube 13 so as to discharge exhaling air through the discharge hose 40 drawn out of the mask M worn by the user.

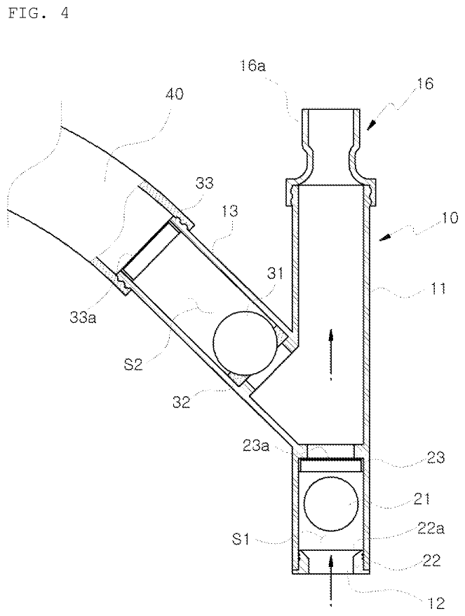

To describe the operation and configuration of the nose breathing device 100 configured as described above in more detail, in an operation in which the user sucks the air while wearing the mask, as shown in FIG. 4, the inhaling check ball 21 moves to the inhaling mesh plate 23, and the exhaling check ball 31 moves so as to be seated on the exhalation ball blocking ring 32, so that the user may suck the air supplied through the air suction port 12 in a state where the air outlet port 14 is closed.

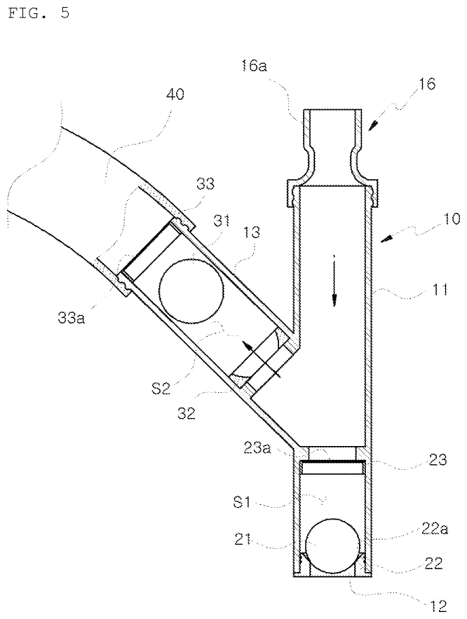

Further, in the operation of discharging the air, as shown in FIG. 5, the exhaling check ball 31 moves to the exhaling mesh plate 33, and the inhaling check ball 21 moves so as to be seated on the inhalation ball blocking ring 22, so that the air is discharged to the outside of the mask M through the discharge hose 40 connected to the air outlet port 14 in a state where the air suction port 12 is closed.

In addition, according to an embodiment of the present invention, the present invention includes a purification device 50 which is connected so as to filter and discharge harmful substances such as viruses and the like, included in the air discharged through the discharge hose 40 in a state where the user is a virus carrier.

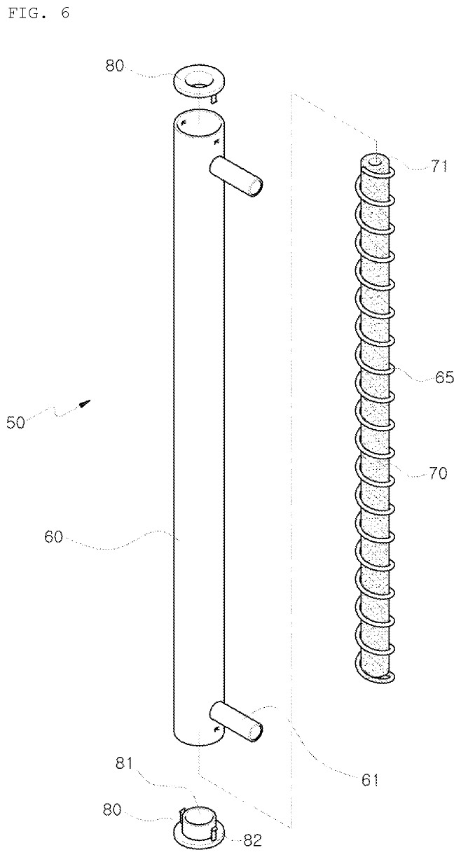

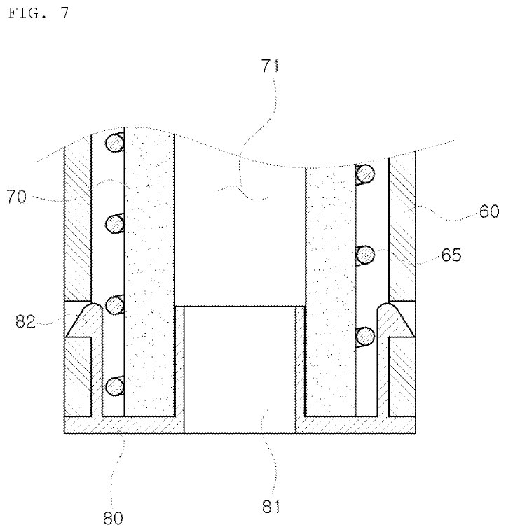

The purification device 50 is connected to a pair of discharge hoses 40 and is configured in a neckband type that is put on a head or a neck of the user at a rear of the user, and a shape of the purification device 50 is not limited to the shape shown in FIGS. 6 and 7 and may be changed in various forms that are put on the neck of the user according to a request of those skilled in the art.

The purification device 50 largely includes a filter tube 60 connected to a hose connector 61, a spiral support 65 provided in the filter tube 60 to support a deformed shape of the filter tube, an adsorption filter 70 for filtering the discharged air, and filter caps 80 assembled to side surfaces of the filter tube 60 to fix the adsorption filter 70.

The filter tube 60 is formed of a soft material and formed into a tubular shape, and is provided at both sides thereof with hose connectors 61 connected to the discharge hoses 40 of the respiratory tube bodies 10, in which the discharge hose 40 is press-fitted into the hose connector 61 or male and female couplings are provided at end portions of the discharge hose 40 and the house connector 61, respectively, so that the discharge hose 40 is detachable from the hose connector 61.

In addition, the spiral support 65 has a coil shape and is inserted into the filter tube 60 to maintain the deformed shape of the filter tube 60 when the filter tube 60 is deformed to be put around the head and the neck of the user at the rear of the user, and may be injection-molded together with the filter tube 60 or may be independently assembled and used, and may be changed in various forms according to a request of those skilled in the art.

In addition, the adsorption filter 70 has a cylindrical shape, is formed at an inside thereof with a central discharge path 71 extending in a longitudinal direction, and is assembled at the inner center of the spiral support 65, so that the air introduced through the hose connector 61 of the filter tube 60 is filtered while harmful substances are adsorbed to a filter material, and then moves through the central discharge path 71.

In addition, the filter caps 80 are assembled to both end portions of the filter tube 60, are provided at the center thereof with an air discharge port 81 communicating with the central discharge path 71, and are formed to have a step in an inward direction facing the filter tube 60, so that the filter caps 80 are fitted into the central discharge path 71 of the adsorption filter 70.

In addition, engaging protrusions 82 protrude from circumferences of the filter caps 80 at a predetermined interval and are fitted into and assembled to engaging grooves formed in the end portions of the filter tube 60 facing each other.

In this case, the filter cap 80 and the spiral support 65 are fitted and assembled between the air discharge port 81 of the filter cap 80 and the engaging protrusions 82, thereby preventing movement of the adsorption filter accommodated therein even when the purification device 50 is bent and shaken, and discharging the air exhaled by the user and discharged through the air discharge port 81.

As described above, the above-described embodiments are described with respect to the most preferred embodiments of the present invention, but are not limited to the embodiments, and it will be apparent to those skilled in the art that various modifications can be made without departing from the technical spirit of the present invention.

1. A nose breathing device comprising:
a pair of respiratory tube bodies (10) including inhaling tubes (11), which are inserted into a nose of a user, and exhaling tubes (13), which are branched from sides of the inhaling tubes (11);
an inhaling check valve (20) which is assembled in an inhaling air accommodation space (S1) of the inhaling tube (11) and is operated so that an air suction port (12) is opened during inhalation and is closed during exhalation;
an exhaling check valve (30) which is assembled in an exhaling air accommodation space (S2) of the exhaling tube (13) and is operated so that an air outlet port (14) is closed during inhalation and is opened during exhalation; and
a discharge hose (40) which is assembled to a front end portion of the exhaling tube (13) to discharge exhaling air to an outside of a mask (M),
wherein the inhaling check valve (20) includes:
an inhaling check ball (21) which has a spherical shape and moves along the inhaling air accommodation space (S1);
an inhaling mesh plate (23) which is supported by a fixed protruding jaw (15) provided inside the inhaling tube (11) so as to control inward movement of the inhaling check ball (21) and allow air to move through a plurality of inhaling ventilation holes (23a); and
an inhalation ball blocking ring (22) which is assembled to a front end portion of the inhaling tube (11) such that an inhalation ball locking jaw (22a) is positioned on an inner surface of the inhaling tube (11) so as to control movement of the inhaling check ball (21) to a front end side of the inhaling tube (11).

2. The nose breathing device of claim 1, wherein the respiratory tube body (10) has a soft silicone insertion member (16) assembled to a front end of the inhaling tube (11) and making close contact with an inner wall surface of the nose of the user.

3. The nose breathing device of claim 1, wherein the exhaling check valve (30) includes:
an exhaling check ball (31) which has a spherical shape and moves along the exhaling air accommodation space (S2);
an exhalation ball blocking ring (32) which is supported by a fixed protruding jaw (15) provided inside the exhaling tube (13) so as to control inward movement of the exhaling check ball (31); and
an exhaling mesh plate (33) which is assembled to the front end portion of the exhaling tube (13) so as to control movement of the exhaling check ball (31) to a front end side of the exhaling tube (13) and allow the air to move through a plurality of exhaling ventilation holes (33a).

4. The nose breathing device of claim 1, wherein the respiratory tube body (10) is assembled by fitting an outer surface of the inhaling tube (11) into at least one tube connection member (19) formed at both sides thereof with tube fitting holes (19a) that are opened.

5. The nose breathing device of claim 1, wherein the discharge hose (40) has an adsorption filter (70) accommodated therein, and is connected to a purification device (50) supported on a circumference of a head or a neck of a wearer at a rear of the wearer so as to filter harmful substances in the air discharged through the discharge hose (40) and discharge the filtered harmful substances.

6. The nose breathing device of claim 5, wherein the purification device (50) includes:
a filter tube (60) which has a tubular shape and is provided at both sides thereof with hose connectors (61);
a spiral support (65) which is inserted into the filter tube (60) and supports a shape of the filter tube (60);
an adsorption filter (70) which has a cylindrical shape and formed at an inside thereof with a central discharge path (71) extending in a longitudinal direction to filter the air introduced through the hose connectors (61) of the filter tube (60) so as to allow the filtered air to move through the central discharge path (71); and
filter caps (80) which are assembled to opposite end portions of the filter tube (60) so as to fix a position of the adsorption filter (70) and includes an air discharge port (81) communicating with the central discharge path (71).
